(19) United States
(12) Patent Application Publication
(10) Pub. No.: US 2009/0327904 A1
(43) Pub. Date: Dec. 31, 2009

(54) PRESENTING DYNAMIC FOLDERS

(75) Inventors: Chris J. Guzak, Kirkland, WA (US); Paul A. Gusmorino, Seattle, WA (US); Relja B. Ivanovic, Seattle, WA (US); Kenneth M. Tubbs, Issaquah, WA (US); Lyon K.F. Wong, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/163,566

(22) Filed: Jun. 27, 2008

(51) Int. Cl. G06F 3/00

(52) U.S. Cl. 715/738

(57) ABSTRACT

Methods and systems are illustrated for defining and presenting a location that is virtual and composed of items from different file system locations to a user interface. Items that have been published over a network can be easily accessed and efficiently browsed when there is a large number of data items shared. The data items shared can be from multiple locations and/or multiple clients that have been published over a network, which can be retrieved, defined and presented directly in a user interface.

### BACKGROUND

Existing sharing and discovery models (e.g., storage and retrieval techniques across a network) publish pointers or paths to locations, but rely on a provider of that location to determine what results are shown. For example, to observe a user profile folder and its contents over a network, a user drills (navigates) through the network by manually opening the network folder, then through to a user client folder, through to a user folder, and finally to a folder structure to obtain access to an individual user's folder or file of a client (e.g., user, machine, or software hosted by a network). Therefore, the way to obtain profile information (e.g., user file content) is to drill through the network. In other words, existing data storage and retrieval systems have data objects stored in sequential predefined categories retrieved by navigating through a folder structure. A common storage technique of data objects is folder-based storage wherein data objects are stored according to predefined or user defined hierarchies and through a known sequencing operation a data object can be retrieved. In such storage, the data objects may include directories (e.g., information data bases), data files (e.g., word documents, or other file types), applications (e.g., MATLAB, media player, etc.), folders (e.g., My documents, My Music, User File folder, etc.), or any other suitable type of electronically stored element or component resource. One example of a folder based storage is a visual computing environment with a graphical user interface illustrating actual file folders or other icons with associated text. The user physically navigates (e.g., drills) to these folders to find or store a particularly known file or location.

Numerous problems with the existing sharing and discovery techniques are present in remote network to user interfacing settings. Multiple users share resources to be published on the network for other users at other machines to access and/or benefit from the network. However, a user must navigate through the network to a root directory and then through various folder and sub-folder sequences. The static nature of the hierarchy (e.g., folder arrangement and sequence) requires knowledge of the folder and sub-folder sequences. Thus, in order to retrieve the same data object after it has been stored, the original user or other users of other clients connected to the network must recreate the navigation (e.g., drill through the same sequence) each time for access. Thus, the root-folder-sub-folder sequence has to be commonly known.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, methods and systems for defining and presenting dynamic folders (e.g., logical/virtual folders) over a network to a client. Published data shared in a folder structure is presented in a schema across a network to a navigation pane to provide easy access. The published data is shared data on the network (e.g., a remote network) that may comprise user profile directories, files, folders, and any suitable electronic element or component from other clients and/or machine drives that have published shared data items onto a network. These data items can be promoted automatically onto a retrieving client for easy access to shared resources and/or data items from multiple sharing clients across the network.

In other words, methods and systems for simplifying the process of locating files spread over a network comprising multiple computers. More particularly, data stored in a plurality of network locations by a plurality of users is presented in a single navigation window, wherein the single navigation window comprises different categories (e.g., folders) having content from a plurality of network locations, therefore providing content from the plurality of computers in a single location. For example, music files stored over a plurality of network locations (e.g., computers) are presented to a user in a single folder of a navigation pane, therefore providing shared music files from the entire network to a single location so that the user doesn't have to navigate through a complex filing system to find shared music.

Another embodiment is to easily expose shared locations from a shared computer on a remote network in order to advertise data objects and/or resources for multiple users at once. By advertising shared resources from a network, other clients are provided access to these shared resources that have been published without navigating through network structures or folder-sub-folder structures to find them. Further, these shared resources get promoted to other user clients with metadata (e.g., data about data) to make them available efficiently and effectively by presenting users their location and/or additional data about the content.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary client/server system.

FIG. 2 is an illustration of an exemplary hierarchy structure.

FIG. 3 is an illustration of an exemplary hierarchy structure.

FIG. 4 is a flow chart illustrating an exemplary method of presenting shared data items.

FIG. 5 is a flow chart illustrating an exemplary method of presenting shared data items.

FIG. 6 is an illustration of an exemplary system for presenting shared data items.

FIG. 7 is an illustration of an exemplary system for presenting shared data items.

FIG. 8 is an illustration of an exemplary system for presenting shared data items.

FIG. 9 is an illustration of an exemplary system for presenting shared data items.

FIG. 10 is an illustration of an exemplary system for presenting shared data items.

FIG. 11 is an illustration of an exemplary system for presenting shared data items.

FIG. 12 is an illustration of an exemplary computer-readable medium comprising processor-executable instructions configured to embody one or more of the provisions set forth herein.

FIG. 13 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

More efficient methods and/or systems for representing other users of different sharing client file structures in the same structure (e.g., file structure) would provide ease of access and improved network performance. For example, a schema can be created where publishing locations are expressed richly (associated with metadata) to include a structure (e.g., a hierarchical structure) of the published location and logic for how to handle its sub-containers and/or files that can reside therein. This is beneficial for example, in shell namespace (e.g., a system of organization for presenting a file system and/or other objects to a user) destinations that have a logic/virtual view (e.g., not a physical file system view). Objects inside the shell namespace can be real file system files and folders, as well as virtual objects like My Network Places and/or Recycle Bin.

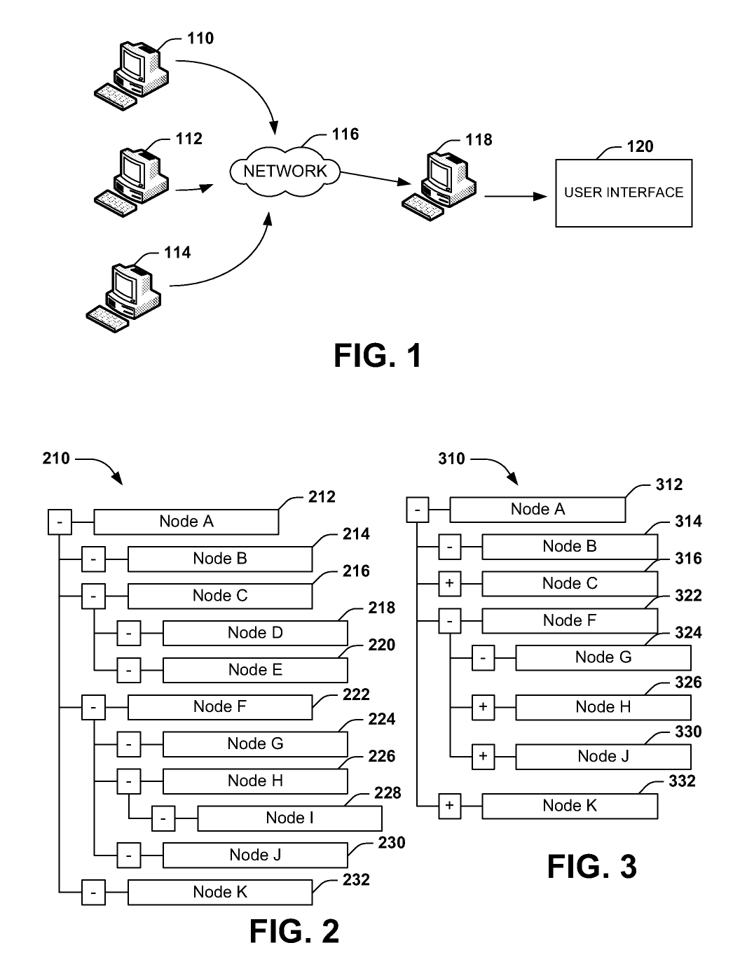

Referring now to FIG. 1, illustrates an exemplary client/server system whereby shared resources shared by a sharing client on behalf of a user can be published on a network and presented to a receiving client. FIG. 1 illustrates three sharing clients (e.g., an application or system that accesses a remote service on another computer system, known as a server, by way of a network), for example, sharing client 110, sharing client 112, and sharing client 114. All of these sharing clients can be at various locations while sharing any form of data to the network 116. For example, the sharing clients may comprise a kitchen PC, home PC, an office PC, or work system or any client at any location able to connect to network 116. This data is then presented to a retrieving client 118, for example.

The shared data items, for example, may comprise data items from a user's file folder that a user would like to share out onto the network 116. To easily promote these data items shared by sharing clients 110, 112, 114 the data items are published onto the network 116 and then presented to retrieving client 118 (who can also share data items over the network) in a user interface 120 for display.

In one embodiment, the retrieving client 118 does not have to drill through (e.g., navigate through) a file system structure, but instead is presented with the published data on the network directly in a display via the user interface 120, for example. This can prevent the retrieving client from having to first know exactly where a shared data item is located and then navigate (drill) through the complicated network folder system, then to the user file system, then to the user's file folder and then to the data item being shared, for example. Further, the retrieving client does not even need to know that there is a newly shared data item from any particular sharing client because the data item is presented upfront in the user interface. The user interface 120 may comprise a navigation (nav) pane, for example. In another example, the user interface 120 may be presented in navigation pane in a windows explorer window. Any hierarchical structure of presentation may be embodied.

FIGS. 2-3 illustrates an example of a hierarchical organization commonly used by networks for storing data and/or data items, as well as techniques for display and navigation through such data sets. A hierarchically organized set of such data items, (such as nodes), may be organized with one or more items at the topmost level, known as root nodes. Each node may contain any number of subordinate items, known as child nodes, which may in turn contain any number of subordinate items, etc. A node may also contain no child nodes, therefore serving as a leaf node. This organizational structure provides for a hierarchy of containment, where each node except for the root node(s) is contained within one higher-level node (known as a parent node.)

Hierarchical data organization may be used in several contexts. As one example, data stored in a format complying with an Extensible Markup Language (XML) schema is organized hierarchically, such that the XML data set contains at most one root node, and each data item except for the root node is contained within exactly one higher-level XML data item. In this example, containment represents nesting, which leads to a fully nested, strictly hierarchical data set.

Hierarchical data sets are often displayed through a treeview graphical user control, in which the individual nodes may be opened or closed to show or hide (respectively) the child nodes contained therein. An exemplary treeview is illustrated in FIGS. 2-3, each presenting a treeview of the same hierarchical data set in two different view states. FIG. 2 depicts the hierarchical data set 210 as containing a root node 212, Node A, that solely comprises the topmost level of the hierarchy, and that directly or indirectly contains all of the other nodes. For instance, Node A 212 directly contains Node B 214, Node C 216, Node F 222, and Node K 232, which together comprise the second level of the hierarchy. Node C 216 further contains Node D 218 and Node E 220, while Node F 222 further contains Nodes G 224, H 226, and J 230, and Node H 226 further contains Node I 228.

Treeview user controls may be used to display very large hierarchical data sets comprising millions of nodes, but displaying all of the nodes would be cumbersome for user navigation. The treeview therefore allows each node to be displayed in an open or closed state, where a node in an open state (denoted by a “−” sign) is shown with all of the child nodes, while a node in a closed state (denoted by a “+” sign) is shown with its child nodes hidden. The open or closed state of a node in the treeview may be toggled by the user (e.g., by clicking on the “+” or “−” symbol to the left of the node with a pointing device, such as a mouse.) The treeview depicted in FIG. 3 illustrates the same data set as the treeview of FIG. 2, but with Node C 316, Node H 326, Node J 330, and Node K 332 shown in a closed state (thereby hiding Nodes D and E of FIG. 2 contained within Node C 316, and Node I of FIG. 2 contained within Node H 326.) The hierarchical data set illustrated by the treeview of FIG. 3 still contains Nodes D, E, and I of FIG. 2, but these child nodes are hidden in the current state of the treeview, and may be shown again by opening the respective parent nodes.

The hierarchical organization of the treeview enables the description of nodes according to the respective paths traversed to reach them. For instance, Node H 326 in FIG. 3 may be described as the child node of Node F 322, which is in turn the child node of Node A 312. In reverse direction, Node H 326 may be reached by traversing the hierarchical data set illustrated in FIG. 3 by beginning at Node A 312, navigating (among the child nodes of Node A 312) to Node F 322, and navigating (among the child nodes of Node F 322) to Node H 326. This sequence forms a hierarchical path of Node A 312 : Node F 322 : Node H 326, which may be used to describe the organization of Node H 326 within the hierarchical data set.

In one embodiment, directories, folders, and/or files and any other data items that comprise an electronic format can be shared onto a network by sharing clients publishing the data on the network and presented to users of a user interface by a hierarchical structure. The amount of data items shared on the network can be immense in volume. In one embodiment, sharing clients (e.g., clients publishing data onto a network) can share various data items from their file system onto the network for it to be promoted to a receiving client by presentation in a user interface. The sharing client may be at any location and share any data item from any directory location on their computer. In addition, multiple sharing clients can share data items onto the network, all of which can be presented through the user interface in a hierarchical structure without any requirement of the user to drill through pathways to discover what has been published.

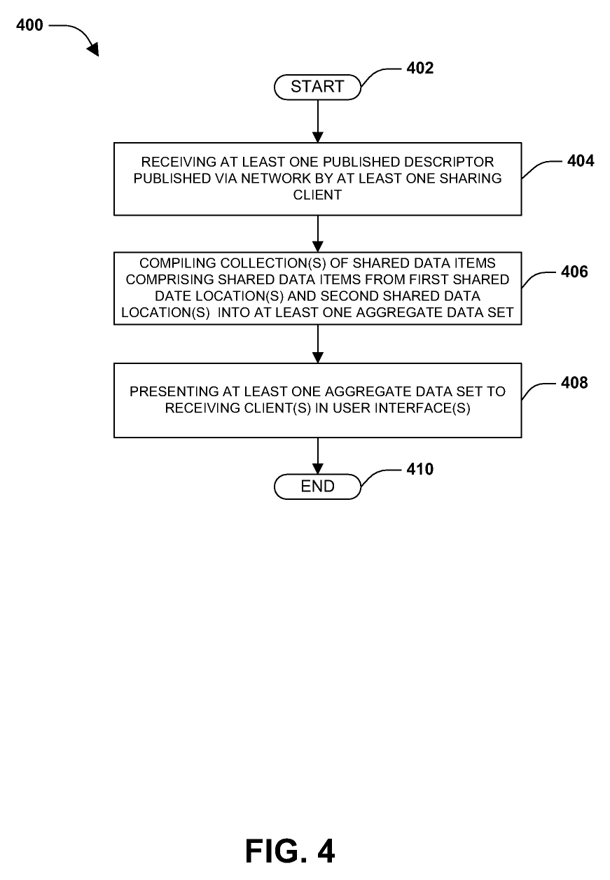

Referring to FIG. 4, illustrates a method 400 for presenting shared data items. The method 400 initializes at 402. At 404, at least one published descriptor published via a network by at least one sharing client is received by a receiving client. The at least one published descriptor (e.g., code describing the object to be presented) may comprise at least one shared resource (e.g., a user's file folder), which encapsulates at least one shared data item, and/or at least one shared data item. A data item may be a file, folder, library, or any other data available within a computing resource (e.g., server, computer, etc.). An example of publishing a published descriptor is where a client designates a photo library as a shared directory, allowing other clients over a network to access the photo library and the photos comprised within the photo library.

At 406, at least one collection of shared data items is compiled into at least one aggregate data set. After a receiving client receiving at least one published descriptor published via network by at least on sharing client, the receiving client discovers the shared resources on the network. The receiving client compiles the data items and presents them in a schema for defining the locations. The client no longer has to drill through the network to discover published resources comprising data items shared, but instead is presented up front or directly in the user interface those data items shared over the network.

The locations defined by the schema can be virtual (e.g., not physically stored in the file system) and composed of data items from different file system locations (e.g., different drives, remote computer clients, user's file folder, etc.). For example, various photos from different client locations can be presented directly through a multitude of respective remote user nodes. The photos may be presented directly in a navigation pane for access through a remote user node, for example, that may correspond to shared resources shared by a user/client via the network.

The photos presented through a node respective of a user/client can be presented in a hierarchical structure, (e.g., a treeview or any other type of structure) that acts as a root node comprising child nodes or any resource that comprises data items shared. The data items may already be published to the network and enumerated in a shared user's folder, for example. The shared resources and/or data items can therein be enumerated and thereafter defined to be presented to a user (e.g., retrieving client) in a user interface.

At least one collection of shared data items may comprise shared data items from a first shared data location and a second shared data location and/or from a multitude of shared data locations. For example, a shared data location may be a server, client computer, or any other location that data may be located and/or shared to a network for being published and presented through a user interface.

A multiple of shared data items and/or shared resources that can be composed of items from multiple different file system locations (e.g., multiple user file folders from multiple remote clients) can be compiled into an aggregate data set. The published descriptor (e.g., an XML code) specifies what shared data items and/or resources can be compiled into the aggregate data set to be presented in the user interface. The shared resources and/or shared data items are compiled for presentation in the user interface along with corresponding metadata (e.g., additional data describing electronic content).

A shared resource can define a set of data items whose content is enumerated in a user interface. The shared resource does not need to be presented and the contents (e.g., files) within the shared resource can be presented in the user interface. For example, if a sharing client shared content within a user's file folder this would be analogous to a user's profile folder in the file system. The folder itself is not shown, however the data items (e.g., files, pictures, and/or any significant electronic document) is presented to a user. Data items comprise individual items (e.g., in a folder) that comprise any significant electronic content. Further, data items encapsulated by the shared resource (contained by the shared resource) may or may not be children of the data items in the shared resource. Also each data item may have a list of attributes describing how the data item can be represented in the user interface. For example, in the case of a user's files folder, the data items can comprise published libraries and/or redirected known folders (e.g., redirected to the network). Published libraries, for example, can have attributes indicating they should be shown in a navigation pane. In addition, data items may have other attributes and/or associated metadata that provides any other additional information for use and/or representation of that data item.

In one embodiment, metadata may comprise a user location, a file name, type, date, size, etc. or any other information pertaining to a data item's content, for example. The metadata, in one embodiment, can aid in defining what should be enumerated for sharing via the network and can be presented along with respective shared data items and/or shared resources of the aggregate set in the user interface. The metadata along with corresponding data items can be presented in the user interface.

At 408, the at least one aggregate data set is presented to at least one receiving client (another client within the network) in at least one user interface. The aggregate data set may comprise any number of user nodes, shared resources, and/or shared data items that have been shared by a user for publishing via the network. A user may comprise at least one of: a person, a hardware component, and a software component.

In one embodiment, an aggregate data set can be presented to receiving client(s) in user interface(s). The user interface can comprise a hierarchical structure, such as a treeview for example, and a navigation pane for displaying and accessing data items of the aggregate data set displayed. The user interface may be any user interface, for example an explorer window. The user interface may comprise remote user nodes and local user nodes that contain respectively shared resources comprising pathways to data items to be presented in the navigation pane, for example, and/or a view pane. The presenting is further discussed infra. At 410, the method 400 finalizes.

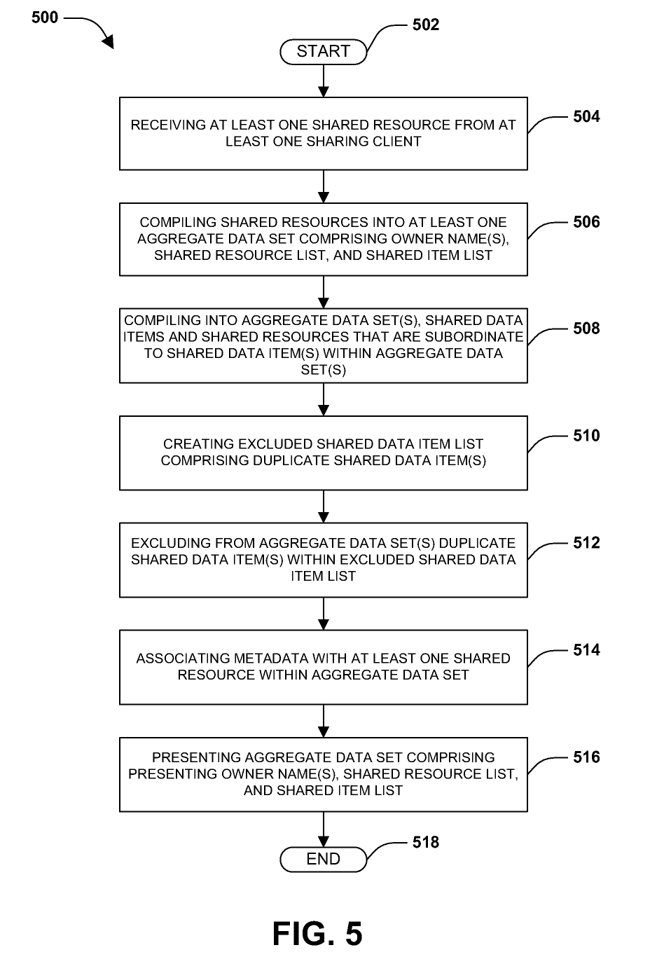

Referring to FIG. 5, illustrates an exemplary method 500 for presenting shared data items that incorporates several of the aspects described herein. At 502, the method initializes. At 504, at least one shared resource is received from a network that has published data from at least one sharing client (e.g., a remote client from a home machine and/or local client to a network). The at least one shared resource may be received via a network from a receiving client where the shared resource encapsulating data items is presented to a user interface.

A shared resource defines a set of data items whose content is enumerated in a user interface. The shared resource does not need to be shown and the contents within the shared resource can be presented in the user interface. Data items comprise individual items (e.g., in a folder) that comprise any significant electronic content. Further, data items encapsulated by the shared resource (contained by the shared resource) may or may not be children of the data items in the shared resource. Also each data item may have a list of attributes describing how the data item can be represented in the user interface.

At 506, a collection of shared resources is complied into at least one aggregate data set. The aggregate data set comprising at least one owner name (name of remote and/or local sharing client), shared resource list (e.g., delegate list), and shared data item list. At 508, in one embodiment, shared data items and/or shared resources that are subordinate (nested) to a shared data item list within the aggregate data set are complied into the aggregate data set. In one embodiment, the shared resource list (e.g., file description list) may be nested into the data item list of the aggregate data set, thereby providing a multi level hierarchy the shared data item list may contain a list of data items to be presented to a user that are from respective locations of various pathways (e.g., directories) and/or different remote client machines. The shared resource list can comprise container items (e.g., data items within a folder structure). These container items may be a group of files under a specific container or folder (e.g., a user's profile folder).

In one embodiment of the method 500 a multi level hierarchy can be created by providing a container list (e.g., the shared resource list (delegate list) and/or shared data item list) within an XML scheme that describes the aggregate data set. The container list can comprise the same compiled data that the aggregate data set uses to describe a first level hierarchy of shared resources and shared data items. The product can be a shared data item list that comprises a subordinate shared data item list (e.g., by nesting) and/or a subordinate shared resource list.

At 510, an excluded shared data item list is created. The excluded shared data item list may comprise duplicate shared data items. These duplicates can comprise files that reside at multiple shared locations from the network, for example. At 512, the duplicate shared data items within the excluded shared data item list are excluded from the aggregate data set. This ensures that duplicate shared data items are not repeated when the aggregate data set is presented.

At 514, metadata is associated with at least one shared resource within the aggregate data set. The metadata may comprise useful information about the sharing client, the shared data, or any other information significant. When the aggregate data set is presented, the metadata may be presented within a navigation pane, for example, or any other structure for presenting metadata.

At 516, the aggregate data set is presented. The aggregate data may comprise at least one owner name, shared resource list, and/or shared item list. The presented aggregate data may exclude duplicate shared data items. The aggregate data set may be presented within a navigation pane, tree structure, hierarchical data structure, or any other structure for presenting data. At 518 the method finalizes.

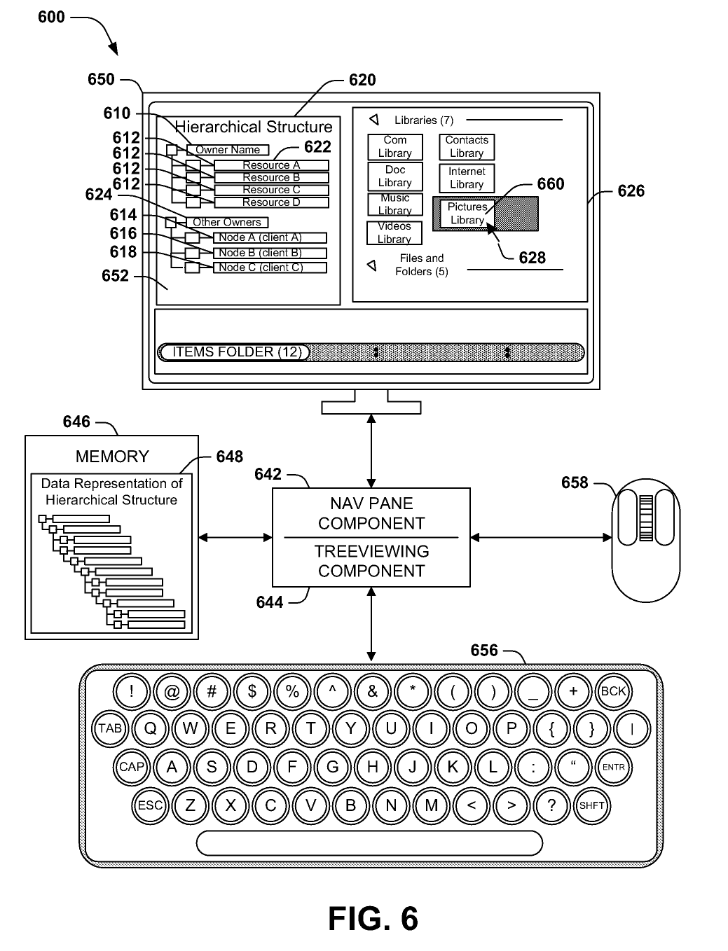

FIG. 6 illustrates an exemplary system 600 for presenting shared data items via a user interface that incorporates several of the aspects described herein. In this exemplary figure, an owner of a receiving client (e.g., a user machine and/or user software receiving network data) may access local data items, such as a pictures library 660, through a user interface 652. The receiving client can be a local user, for example, and displayed as owner name node 610 in a hierarchical structure 620 within the user interface 652. Nodes 614, 616, and 618 may likewise be remote user nodes presented in the user interface 652, for example, as a child of a remote user node, such as an “other owners” node 624.

FIG. 6 further incorporates a navigation pane component 642 comprising a treeviewing component 644, operably coupled with a memory 646 containing a data representation of the hierarchical structure 648. The system 600 also comprises a display component configured to display the hierarchical structure 620 which may be in the form of a scoped treeview, as an example, which is generated by the treeviewing component 644 in a navigation pane 652 generated by the navigation pane component 642 for a selected node in the hierarchical structure. The system 600 also comprises two input devices, a keyboard 656 and a mouse 658, which may be configured to accept user input in relation to the hierarchical structure 620 and/or navigation pane 652. Together, these components generate and display a hierarchical structure 620 and/or a navigation pane 652 for the hierarchical structure 648, and allow user interaction with the hierarchical data set (e.g., facilitated navigation through the nodes of the hierarchical data set 648, 620, and viewing of selected nodes in viewer applications). Navigation can be performed through the hierarchical structure 620 in the navigation pane 652 and presented also in a view pane 626 wherein libraries of shared resources, files, and/or folders, for example, can be shown.

In one embodiment, shared data items may be represented by the type of shared resource they are derived from, such as resource A 622 which is a node (pathway to data item locations). The node resource A 622 can comprise local shared data items and/or remote shared data items from other owners that have been published onto a network and represented virtually by the node labeled resource A as one example. The publishing of these shared data items and/or shared resources has been done over the network with corresponding metadata by any number of publishing services. For example, a sharing client can share pictures of his family to the network. Publications services (e.g., any software application and/or tool for publishing data) publish any of the shared resources (e.g., directories, libraries, user folder, and/or any shared resource encapsulating data items) for a receiving client. The shared resources and/or shared date items that have been published can be compiled into an aggregate data set (e.g., into a shared user folder). These data items can be presented as a child node under resource A, for example, as well as other nodes corresponding to the manner in which shared resources, and/or shared data items have been enumerated or categorized along with any corresponding meta data (e.g., additional information about content).

In one embodiment, an owner name node 610 can be a parent node linking to node 612 encapsulating data items as child nodes in a hierarchical structure, for example a treeview and/or any other viewing structure allowable for presentation and/or navigation. The nodes can have pluses or minus denoting nodes as a parent/child node hierarchy, such as in a treeview, or alternatively may not. The nodes 612 may be published for shared usage onto a network and the data items contained therein can be presented to the receiving client via the user interface 650. The shared resources are shared by owner name 610 (e.g., John, or any owner of the client). The owner name can be the display name of the user publishing the data items shared from different file system locations (e.g., User's File Folder). For example, node 610 and nodes 614, 616, and 618 can all comprise the display name of the user that respectively published data items as shown in the user interface.

In one embodiment, the nodes 610, 614, 616, and 618 can be presented along with metadata, for example the client location such as client A, client B, or client C. The metadata may be any additional data about the content of such nodes, such as the user/client location. For example, Client A is associated with node A. Client A may be metadata describing a particular remote user's owner name node 614 and may read “Home PC,” instead of “1client A.” In another embodiment, client A may be a work PC connected to the same network. Client A can be a descriptor of something else other than a user/client name or location also. Each node can correspond respectively to a client connected to the network wherein shared data items, and shared resources have been published for sharing by multiple clients with multiple file systems corresponding respectively to those same clients.

FIG. 6 illustrates one example of the system 600 that comprises the user interface 650 presenting other users of a client profile in the same hierarchical structure 620 without having to drill through networks to obtain data items. For example, the user interface can present a user profiles folder contents (e.g., data items) and metadata associated with that folder and/or its content data items, which may describe the user profile folder and/or its data items contained therein. As stated above, node A 614 may illustrate a description of a user of the network that can be a remote client. The user interface, in one embodiment, illustrates a representation of that remote client to a local receiving client (e.g., the client viewing the user interface). In addition, node 610 entitled “Owner name” may represent a current user or the local receiving client in other words. Nodes 614, 616, and 618 may represent other users on different machine, and/or other clients on the network that are presented with associated metadata (e.g., client A, client B, client C, which are generic descriptions of any associated attribute to a given client). Remote clients are being promoted in the user interface to any local user with data descriptions associated to respective remote clients. Therefore, data is promoted in the navigation pane, for example, to make it easier for users to navigate. Each node and the share resources encapsulating shared data items are promoted to users locally with descriptions. The data items can come from a multitude of various computer machines, drives, and/or shared data item locations redirected to the network.

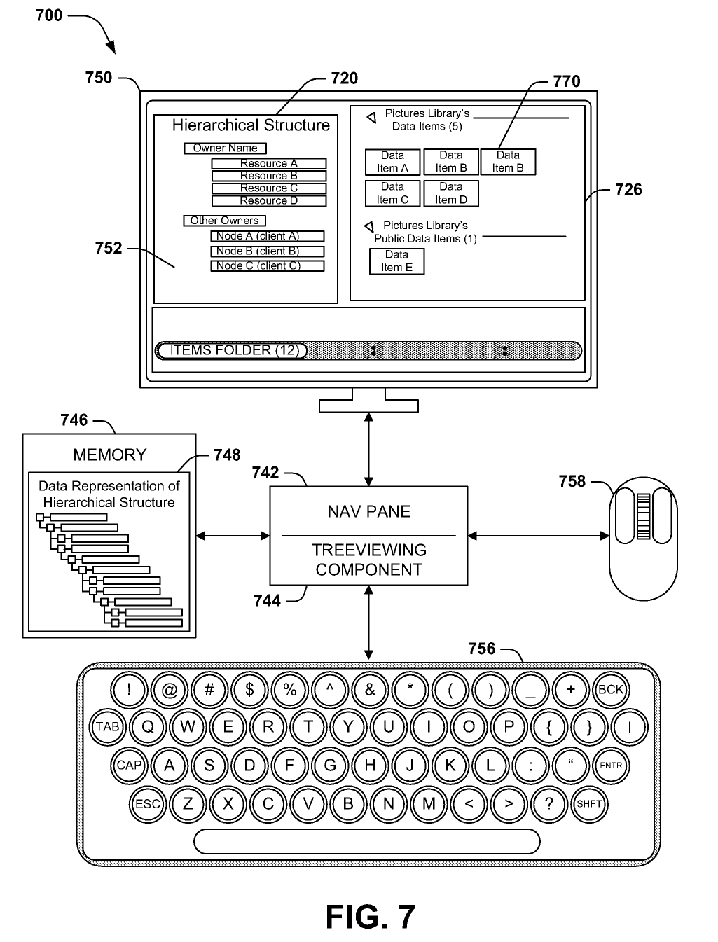

A top level view of shared data being presented in FIG. 6 of a virtual hierarchy instead of a real physical hierarchy. The hierarchy structure is navigable to data items 660 that can be viewed also in the view pane 626. A mouse pointer 628 illustrates clicking on a highlighted data item in the view pane which then presents to the user one exemplary view as given by an example in FIG. 7.

FIG. 7 illustrates a system 700 that incorporates several of the aspects described herein. A treeviewing component 744 and a navigation pane component 742 is incorporated, each component operably coupled with a memory 746 containing a data representation of the hierarchical structure 748. The system 700 also comprises a display component configured to display the hierarchical structure 720 which may be in the form of a scoped treeview, as an example, which is generated by the treeviewing component 744 in a navigation pane 752 generated by the navigation pane component 742 for a selected node in the hierarchical structure 748. The system 700 also comprises two input devices, a keyboard 756 and a mouse 758, which may be configured to accept user input in relation to the hierarchical structure 720 and/or navigation pane 752. Together, these components generate and display a hierarchical structure 720 and/or a navigation pane 752 for the hierarchical structure 748, and allow user interaction with the hierarchical data set 748, 720 (e.g., facilitated navigation through the nodes of the hierarchical data set 748, 720, and viewing of selected nodes in viewer applications). Navigation can be performed through the hierarchical structure 720 in the navigation pane 752 and presented also in a view pane 726 wherein libraries of shared resources, files, and/or folders, for example, can be shown.

In one example, once the pictures library data item is accessed (as shown in FIG. 6), a view pane 726 displays the data items 760 associated within the pictures library shared resource. These data items are local to the user (owner) and further comprise public data items.

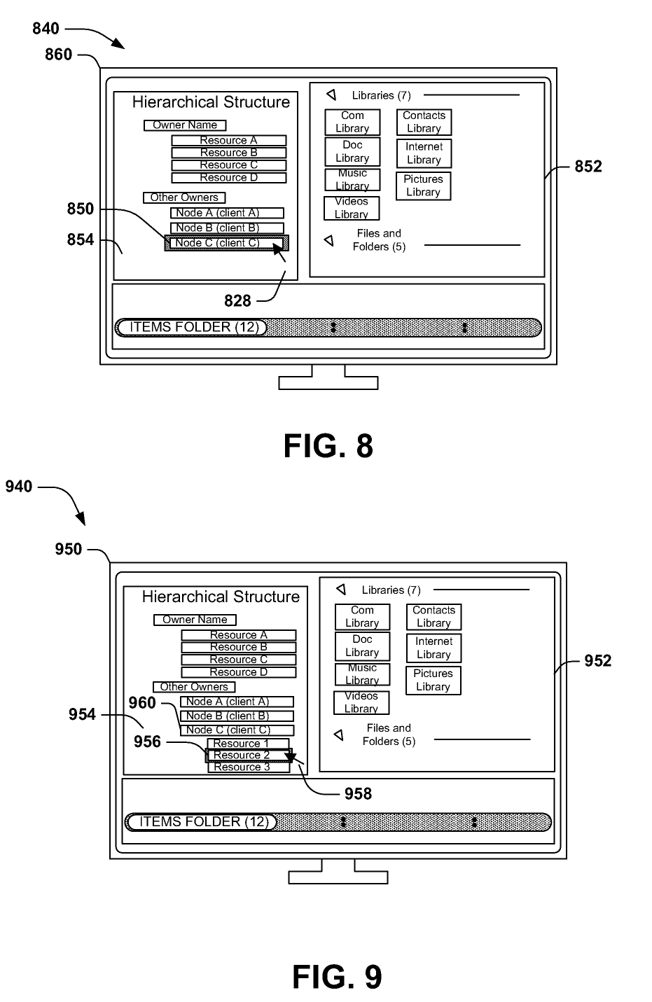

FIG. 8 illustrates an example 840 of a navigation pane 854, where a local user has selected Node C 850. View pane 852 displays local files. Node C 850 represents within the user interface 850 client C, which is a remote client sharing data items and resources over a network. A mouse pointer 828 illustrates accessing Node C 850 which presents the user one exemplary view as given by an example in FIG. 9.

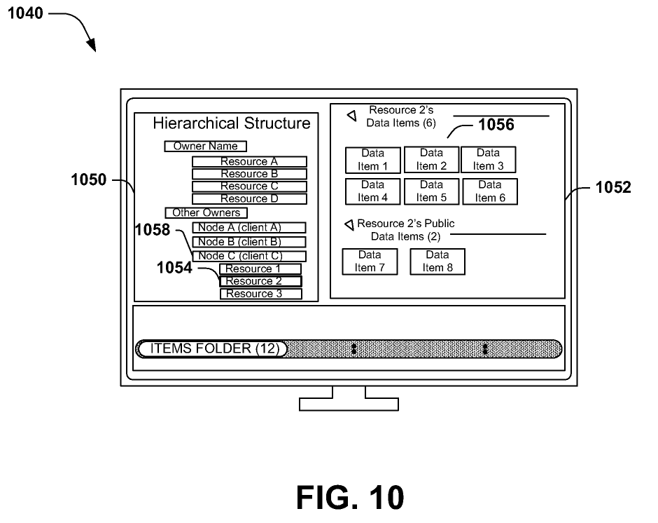

FIG. 9 illustrates an example 940 of a navigation pane 954, where a local user has selected Node C 850. The view pane 952 displays local files. Resource 2 956 represents shared resources that client C 960 has shared over a network comprising shared data items. A mouse pointer 958 illustrates accessing Resource 2 956 which presents the user one exemplary view as given by example in FIG. 10.

FIG. 10 illustrates an example 1040 of a navigation pane 1050 and a view pane 1052. Resource 2 1054 has been accessed and highlighted. Resource 2 1054 is a shared resourced by client C 1058. Resource 2 has shared data items 1056, which are displayed within the view pane 1052.

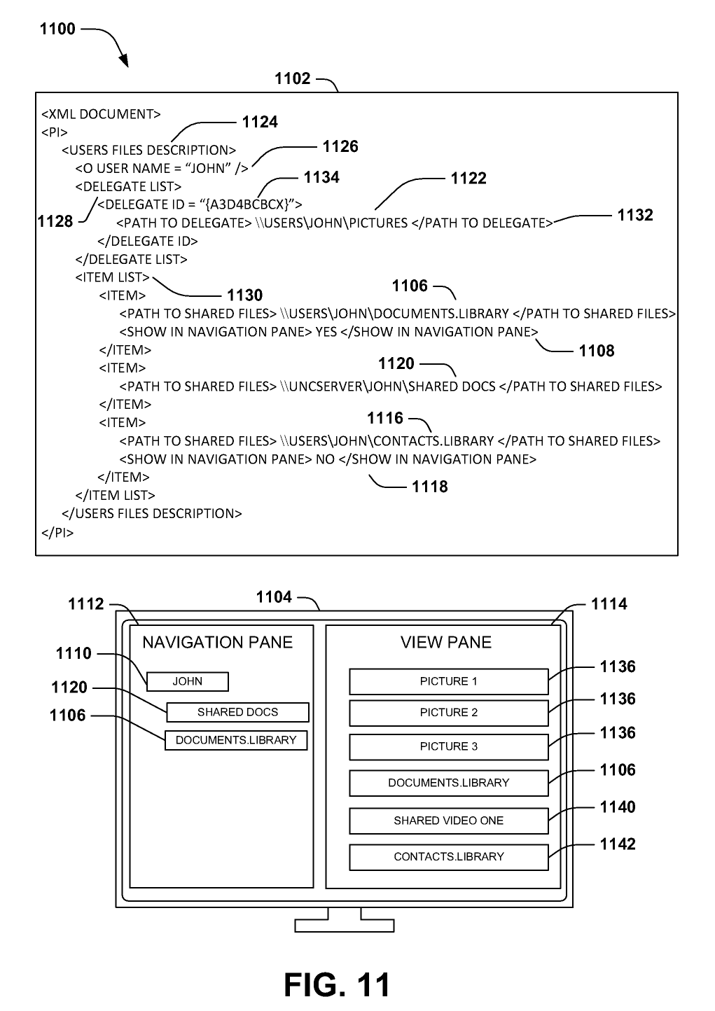

FIG. 11 illustrates an example 1100 of presenting shared data items via a user interface 1104 by means of an XML schema file 1102. The XML schema file 1102 is a text description that describes data. In the present example, the XML schema file 1102 describes items that a sharing client has shared. The sharing client (user), John 1110, is sharing a documents.library 1106 file, contacts.library 1116 file, a shared docs 1120 folder, and a pictures 1122 delegate. The user interface 1104 comprises a navigation pane 1112 and a view pane 1114. The navigation pane 1112 displays users (local and remote/“other”) that may share information over the network. Each user may comprise shared data resources encapsulating shared data items that a user may navigate through. The view pane 1114 may comprise shared data items that a user may access.

The user files description tag 1124 (e.g. master tag) which defines a collection that describes the user file (John's 1110 shared files). The sharing client, John 1110, is displayed within the navigation pane 1112. John 1110 is designated as an “owner” node because of the “o” before the user name tag and can represent other remote user clients. Information, shared items, and shared resources for John 1110 appears where “other” nodes are designated to appear within the navigation pane 1112.

A delegate list 1128 and an item list 1130 describe the data that appears under John 1110. A delegate points to a folder that will not be shown, but the contents of that folder will be shown under the user (John 1110). The delegate list 1128 identifies the pictures 1122 delegate. The delegate list 1128 comprises a delegate ID tag 1134, which indentifies a delegate that John 1110 is sharing. The path to delegate tag 1132 identifies the location of the delegate folder. The contents picture 1, picture 2, and picture 3 1136 of the pictures 1122 delegate are displayed within the view pane 1114.

The item list 1130 describes the items documents.library 1106, shared docs 1120, and contacts.library 1116. Items may reside within a delegate folder or any other place the user has shared access to. The illustration in navigation pane tag 1108 is set to yes, therefore, specifying that documents.library is displayed within the navigation pane 1112. The documents.library is displayed within the view pane 1114 because it is an item that John 1110 has shared. In contrast, contacts.library 1116 is a shared file that appears within the view pane 1114, but not within the navigation pane 1112. Contacts.library 1116 is not displayed within the navigation pane 1112 because the show in navigation pane tag 1118 is set to no. The show in navigation pane 1112 may be used as a filtering mechanism to filter unimportant shared items, resources, or duplicates.

The shared docs 1120 item may be a folder that John 1110 designated as a shared folder for other users to access. The shared docs 1120 item appears in the navigation pane 1112 as a shared folder that a user can navigate to. A shared video one 1140 file is comprised within the shared docs 1120 item (folder). The shared video one 1140 file is accessible within the view pane 1114.

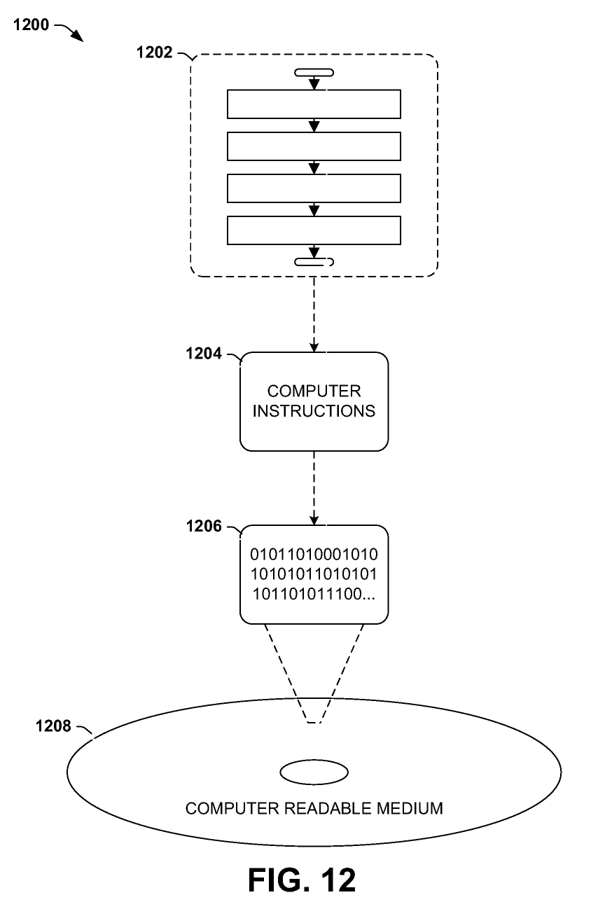

Still another embodiment involves a computer-readable medium comprising processor-executable instructions configured to implement one or more of the techniques presented herein. An exemplary computer-readable medium that may be devised in these ways is illustrated in FIG. 12, wherein the implementation 1200 comprises a computer-readable medium 1208 (e.g., a CD-R, DVD-R, or a platter of a hard disk drive), on which is encoded computer-readable data 1206. This computer-readable data 1206 in turn comprises a set of computer instructions 1204 configured to operate according to one or more of the principles set forth herein. In one such embodiment, the processor-executable instructions 1202 may be configured to perform a method, such as the exemplary method 400 of FIG. 4, for example. In another such embodiment, the processor-executable instructions 1202 may be configured to implement a system, such as the exemplary system 1100 of FIG. 11, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

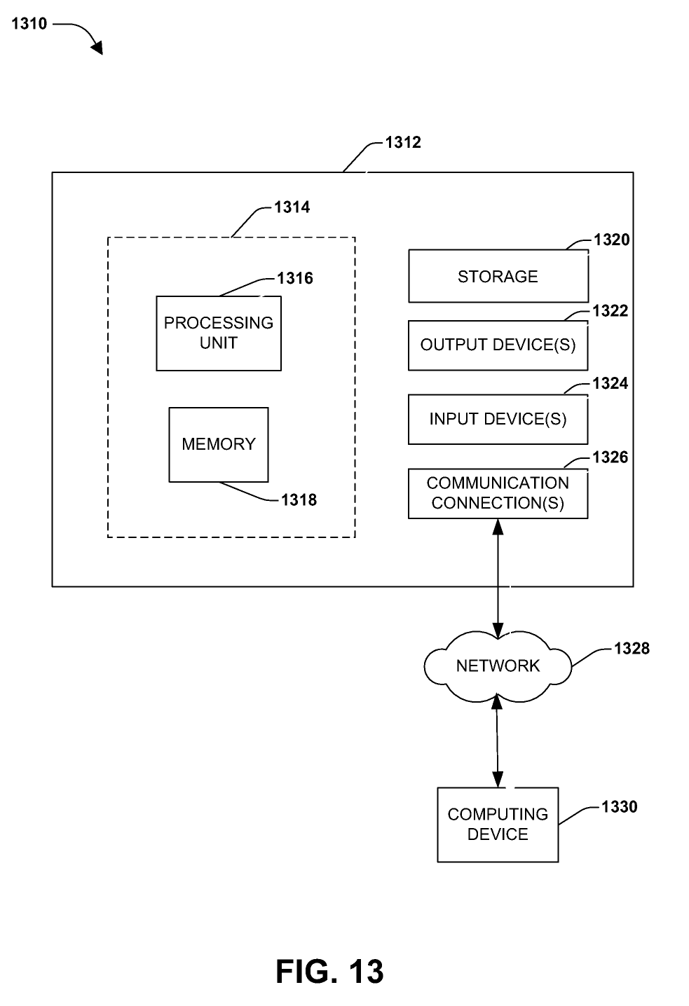

FIG. 13 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 13 illustrates an example of a system 1310 comprising a computing device 1312 configured to implement one or more embodiments provided herein. In one configuration, computing device 1312 includes at least one processing unit 1316 and memory 1318. Depending on the exact configuration and type of computing device, memory 1318 may be volatile (such as RAM, for example), non-volatile (such as ROM, flash memory, etc., for example) or some combination of the two. This configuration is illustrated in FIG. 13 by dashed line 1314.

In other embodiments, device 1312 may include additional features and/or functionality. For example, device 1312 may also include additional storage (e.g., removable and/or non-removable) including, but not limited to, magnetic storage, optical storage, and the like. Such additional storage is illustrated in FIG. 13 by storage 1320. In one embodiment, computer readable instructions to implement one or more embodiments provided herein may be in storage 1320. Storage 1320 may also store other computer readable instructions to implement an operating system, an application program, and the like. Computer readable instructions may be loaded in memory 1318 for execution by processing unit 1316, for example.

The term “computer readable media” as used herein includes computer storage media. Computer storage media includes volatile and nonvolatile, removable and non-removable media implemented in any method or technology for storage of information such as computer readable instructions or other data. Memory 1318 and storage 1320 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1312. Any such computer storage media may be part of device 1312.

Device 1312 may also include communication connection(s) 1326 that allows device 1312 to communicate with other devices. Communication connection(s) 1326 may include, but is not limited to, a modem, a Network Interface Card (NIC), an integrated network interface, a radio frequency transmitter/receiver, an infrared port, a USB connection, or other interfaces for connecting computing device 1312 to other computing devices. Communication connection(s) 1326 may include a wired connection or a wireless connection. Communication connection(s) 1326 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1312 may include input device(s) 1324 such as keyboard, mouse, pen, voice input device, touch input device, infrared cameras, video input devices, and/or any other input device. Output device(s) 1322 such as one or more displays, speakers, printers, and/or any other output device may also be included in device 1312. Input device(s) 1324 and output device(s) 1322 may be connected to device 1312 via a wired connection, wireless connection, or any combination thereof. In one embodiment, an input device or an output device from another computing device may be used as input device(s) 1324 or output device(s) 1322 for computing device 1312.

Components of computing device 1312 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1312 may be interconnected by a network. For example, memory 1318 may be comprised of multiple physical memory units located in different physical locations interconnected by a network.

Those skilled in the art will realize that storage devices utilized to store computer readable instructions may be distributed across a network. For example, a computing device 1330 accessible via network 1328 may store computer readable instructions to implement one or more embodiments provided herein. Computing device 1312 may access computing device 1330 and download a part or all of the computer readable instructions for execution. Alternatively, computing device 1312 may download pieces of the computer readable instructions, as needed, or some instructions may be executed at computing device 1312 and some at computing device 1330.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting shared data items from a first shared data location and a second shared data location from at least one sharing client to a receiving client via a network, where the receiving client presents shared data locations of the plurality of sharing clients through a user interface, the method comprising:
receiving at least one descriptor specifying at least one shared resource encapsulating at least one shared data item published via the network by at least one sharing client;
compiling a collection of shared data items into an aggregate data set; and
presenting the aggregate data set to the receiving client in the user interface, the user interface displaying at least one shared resource from the aggregate data set.

2. The method of claim 1, the user interface displaying a hierarchical structure displaying at least one node respective of at least one data item in the aggregate data set to at least one shared data location.

3. The method of claim 2, the hierarchical structure comprising a tree structure presenting shared data locations to the receiving client, and a user comprising at least one of: a person, a hardware component, and a software component.

4. The method of claim 1, the user interface displaying a navigation pane displaying shared data items and shared data locations comprising a first shared data location comprising a file system location on a first sharing client and a second shared data location comprising a file system location on a second sharing client.

5. The method of claim 4, the first shared data location and the second shared data location comprising pathways specifying at least one shared data item respectively published from the first sharing client on behalf of a first user and the second sharing client on behalf of a second user.

6. The method of claim 1, at least one descriptor comprising a published descriptor comprising metadata.

7. The method of claim 6, the presenting comprising: presenting at least one shared data item associated with metadata in a hierarchical structure of the user interface.

8. The method of claim 1, associating metadata with at least one shared data item, and the presenting the aggregate data set comprising at least one of: presenting an owner name, presenting a shared resource list, and presenting a shared item list.

9. The method of claim 8, the at least one shared data item comprising at least one of:
at least one subordinate shared data item, and
at least one subordinate shared resource.

10. The method of claim 1, comprising: excluding at least one excluded shared data item from the aggregate data set.

11. The method of claim 10:
the excluding comprising: adding the at least one excluded shared data item to an excluded shared data items list; and
the presenting comprising: presenting the items of the aggregate data set that are not included in the excluded shared data items list.

12. The method of claim 10, the at least one excluded shared data item comprising a shared data item having a duplicate shared data item in the aggregate data set.

13. The method claim 1, comprising: upon detecting at least one shared resource on the network, retrieving at least one shared data item of the respective shared resources.

14. The method of claim 4, the shared resources associated with metadata classifying the resource respectively.

15. A method of presenting shared data items from at least one sharing client to a receiving client via a network, where the receiving client presents shared data locations through a user interface, the method comprising:
receiving via the network at least one published descriptor specifying at least one shared resource encapsulating at least one shared data item specifying at least one shared data location, the published descriptor comprising metadata;
upon discovering shared resources, compiling an aggregate data set comprising at least one shared resource; and
presenting the shared data items to the receiving client in the user interface.

16. The method of claim 15, the shared data locations comprising pathways to shared data items specifying at least one shared data item published from at least one sharing client on behalf of at least one user.

17. The method of claim 15, the published descriptor comprises metadata associated with at least one shared data item in the user interface as metadata associated with the shared data items.

18. The method of claim 15, excluding at least one excluded shared data item from the aggregate data set having a duplicate shared data item in the aggregate data set.

19. The method of claim 15, the shared data locations comprising at least two file system locations respectively associated with metadata classifying the at least two file system locations respectively.

20. A method of presenting shared data items from a first shared data location and a second shared data location from at least one sharing client to a receiving client via a network, where the receiving client presents shared data locations of the plurality of sharing clients through a user interface, the method comprising:
receiving at least one published descriptor comprising metadata and specifying at least one shared resource encapsulating at least one shared data item published via the network by at least one sharing client;
compiling a collection of shared data items into an aggregate data set; and
presenting the aggregate data set to the receiving client in the user interface displaying at least one shared resource from the aggregate data set, the presenting comprising at least one of: presenting an owner name, presenting a shared resource list, and presenting a shared item list;
the user interface displaying a hierarchical structure displaying at least one node respective of at least one data item in the aggregate data set to at least one shared data location and displaying a navigation pane presenting shared data items and shared data locations comprising:
a first shared data location comprising a file system location on a first user client and specifying at least one shared data item;
a second shared data location specifying at least one shared data item comprising a file system location on a second user client and specifying at least one shared data item; and
the hierarchical structure comprising a tree structure presenting shared data locations to the receiving client, and a user comprising at least one of: a person, a hardware component, and a software component.
